(19) United States
(12) Patent Application Publication
(10) Pub. No.: US 2007/0104915 A1
(43) Pub. Date: May 10, 2007

(54) Composite label web and method of using same

(76) Inventors: Frank J. Blancato, Marietta, GA (US); Karen L. Euse, Miamisburg, OH (US)

Correspondence Address: PAXAR AMERICAS, INC.;ATTN: JOSEPH J. GRASS, 170 MONARCH LANE, MIAMISBURG, OH, 45342, US

(21) Appl. No.: 11/268,114

(22) Filed: Nov. 7, 2005

(51) Int. Cl. B32B 33/00

(52) U.S. Cl. 428/42.3; 428/40.1

(57) ABSTRACT

There is disclosed a composite label web containing labels and security seals capable of being applied as a unit to articles such as containers using an automatic label applicator. After application to, for example, a container, the seals can be removed from adherence to the container and used as loop security seals.

### FIELD OF THE INVENTION

The field comprises labels, label webs and method of using label webs.

### BACKGROUND OF THE INVENTION

It is known that distributors of magazines and the like load new magazines into containers and label the containers with composite label sheets. The composite label sheets include label sheets and security seals. The label sheets contain information about the stores to which the labels are to be delivered. Route delivery people deliver the labeled containers of magazines to stores in their trucks. When the container has been unloaded of new magazines at the store, the delivery people load unsold or old magazines for return delivery to the distributor. The distributor grants a refund or credit to the store for the unsold, returned magazines. Once the unsold magazines have been loaded into the containers (which still contain the composite label sheets) by the delivery people, the delivery people remove the security seals from the composite label sheets and use them to seal the containers. If the security seals are tampered with, e.g., undone or broken when a returned container is received by the distributor it indicates tampering, in particular, that some of the magazines may have been pilfered, so the distributor is particularly watchful to see that the store is only granted a refund or credit for the magazines actually received by the distributor. This prior art is further described below in connection with FIGS. 13 through 17.

### SUMMARY OF THE INVENTION

The invention relates to improved composite labels, composite label webs, and methods of using composite label webs. The composite label web includes a carrier web and label sheets or labels disposed along the length of the carrier web. Each label sheet includes a label and at least one and preferably two security seals. The label sheets are releasably adhered by pressure sensitive adhesive to a carrier sheet. The label sheets include labels that carry data. The carrier web is free of any cut that would prevent application of the label sheets onto articles to be labeled. The label sheets are especially capable of being dispensed from and applied directly to articles such as containers using a label applicator. A method of the invention includes providing a composite label web of label sheets having a carrier web with a release coating, and label sheets disposed along the carrier web and having pressure sensitive adhesive releasably adhering the label sheets to the release coating on the carrier web, wherein each label sheet has cut lines to define at least one label and at least one security seal, applying the label(s) and the security seal(s) adhesively to a container to be labeled, thereafter peeling the seal(s) from the container, and applying the seal(s) to the container to indicate tampering if the seal or seals are broken or otherwise defeated. It is preferred to peel the entire label sheet from the carrier web for application to the container by the label applicator.

### BRIEF DESCRIPTION OF THE DIAGRAMMATIC DRAWINGS

FIG. 1 is a top plan view of a composite label web in accordance with the invention;

FIG. 2 is a bottom plan view of the composite label web shown in FIG. 1;

FIG. 3 is an enlarged sectional view taken along line 3-3 of FIG. 1;

FIG. 4 is an enlarged sectional view taken along line 4-4 of FIG. 1;

FIG. 5 is an enlarged sectional view taken along line 5-5 of FIG. 1;

FIG. 6 is a diagrammatic view of a printed label sheet of a composite label web being applied to a container by a label applicator;

FIG. 7 is an elevational view of a fragmentary portion of a container and a label sheet adhered to the container by pressure sensitive adhesive;

FIG. 8 is a top plan view of a printed label sheet adhered to a container;

FIG. 9 is a top plan view of a label of the label sheet adhered to a container;

FIG. 10 is a top plan view of security seals which have been peeled from the container;

FIG. 11 is a perspective view of a container to which the security seals have been applied to indicate tampering;

FIG. 12 is a perspective view showing how a security seal is formed into a closed loop;

FIG. 13 is a top plan view of a prior art composite label web;

FIG. 14 is a bottom plan view of the prior art composite label web shown in FIG. 13;

FIG. 15 is a bottom plan view of the prior art composite label sheet of FIGS. 13 and 14 from which the security seals and a portion of the carrier sheet have been removed;

FIG. 16 is an elevational view of the portion of the composite label sheet shown in FIG. 15 adhered to a container; and

FIG. 17 is a bottom plan view of the security seals on an associated portion of the carrier sheet.

### DETAILED DESCRIPTION OF THE PREFERRED EMBODIMENTS

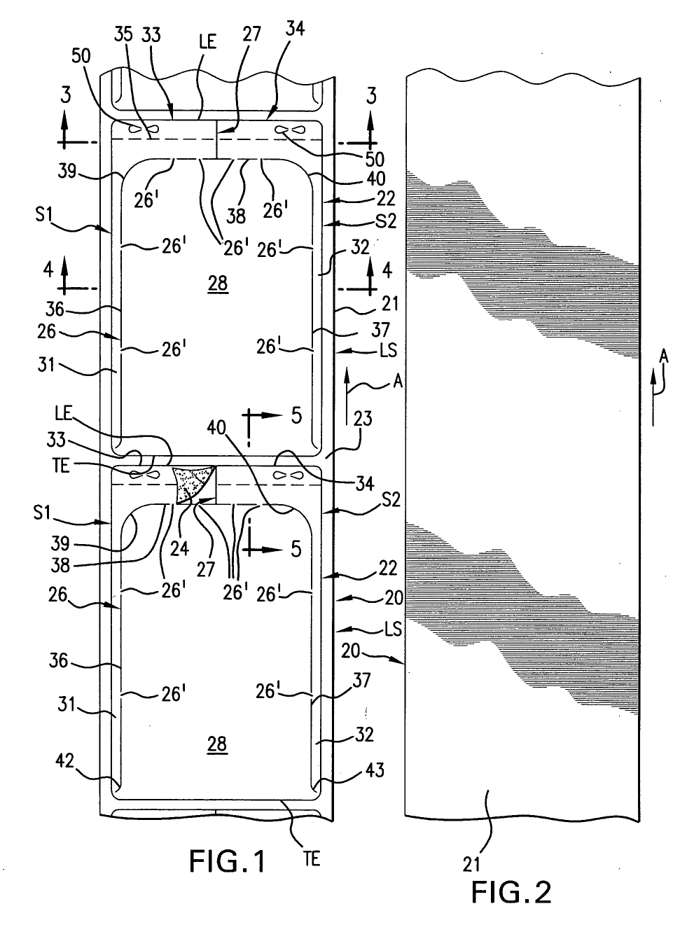

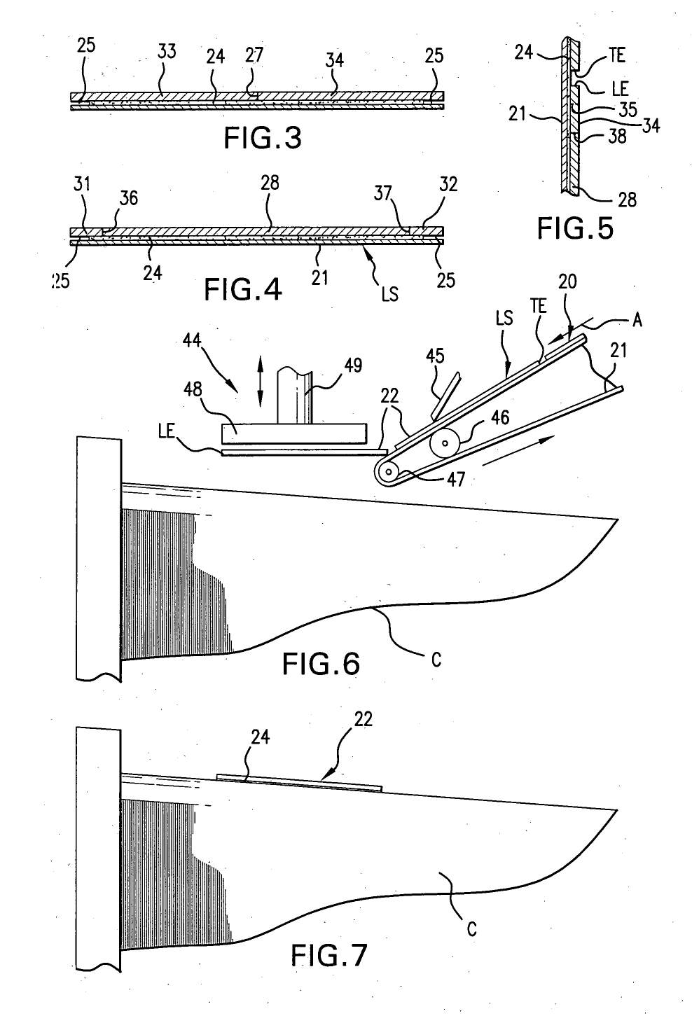

In FIGS. 1 and 2, there is shown a composite label web generally indicated at 20 which includes a carrier web 21 and label sheets generally indicated at 22. The carrier web 21 has an upper face 23 having a release coating such as silicone across and along the entire face 23. The label sheets 22 preferably have a uniform coating of a pressure sensitive or tacky adhesive 24 on their undersides except for adhesive-free or tack-free areas or zones at their marginal longitudinally extending side edges 25 (FIGS. 3 and 4). The adhesive 24 is releasably adhered to the release coating on the upper face of the carrier web 21. The marginal side edges 25 can be rendered non-tacky either by omitting the adhesive or by applying an adhesive deadener over the adhesive 24. It is preferred that adhesive-free or non-tacky zones exist along the entire longitudinal side edges 25 of the label sheets 22. Each label sheet 21 and the underlying portion of the carrier web 21 comprises a composite label sheet LS. The label sheets 22 are shown to be fully die cut as is preferred. A fully die cut label or label sheet, such as a label sheet 22, is said to be fully die cut when all the label material or matrix around a label or label sheet has been removed. However, the label sheet 22 can be semi-die cut or butt cut, if desired. A semi-die cut label is one wherein no label material or matrix is removed between label sheets, but label material or matrix is removed at the side edges of the label sheet. A typical butt cut label is one in which the label material is coextensive with the carrier web and no label material has been removed between end-to-end labels.

The label sheets 22 are cut at a cut line or cut generally indicated at 26 and at a cut line or cut generally indicated at 27. The cut 26 is shown to be generally U-shaped to define a label 28. The cuts 26 and 27 define at least one and preferably two security seals generally indicated at 29 and 30 as shown. The label 28 is generally rectangular in configuration. Each label sheet 22 can be cut to provide one or more than two security seals S1 and S2. The seals S1 and S2 are shown to be generally L-shaped with respective longitudinally extending leg portions 31 and 32 and transversely extending bight or transverse portions 33 and 34. A transversely extending line of partial severing 35 in the transverse portions 33 and 34 of such as perforation cuts are shown by a dash-dash line. The partial severing 35 can take a variety of forms such as perforations, scoring, intermittent blanking or the like. The cut 26 has longitudinal cut portions 36 and 37 and a transverse or bight cut portion 38 joined to each other at gradual curved cut portions 39 and 40. The cut line or cut 27 preferably extends to the leading end LE of the label sheet 22 and to the center of the bight or cut portion 38. The leg portions 31 and 32 formed by the cut 26 preferably extend to just short of the trailing end TE of the label sheet 22, and the cut 26 preferably terminates at radiussed ends 42 and 43. The cut 26 is shown to be interrupted by short, frangible portions or lands 26′ which help the entire label sheet LS to be dispensed in tact into label applying relationship to applicator pad 48 and applied in tact to a container. The label sheet LS, therefore, does not become separated from the seals S1 and S2 while the label sheet LS is being dispensed by an automatic label applicator as shown at 44 in FIG. 6. The lands 26′ are spaced from ends 42 and 43 so that preferably two frangible portions 26′ are disposed at leg portions 31, two frangible portions 26′ are disposed at leg portions 32, two frangible portions 26′ are disposed at transverse portion 33, and two frangible portions 26′ are disposed at transverse portion 34. It is only when the seals S1 and S2 are intentionally manually separated from the label 28 by the user after the entire label sheet LS has been applied to the container C that the frangible portions 26′ are torn as the seals S1 and S2 are peeled from the container C.

As shown especially in connection with FIGS. 2 through 5, the complete cuts 26 and 27 extend through the label sheet 22, but not through the carrier web 21, and the partial severing 35 extends into the label sheet 22 to weaken it without completely severing it so that it can form a hinge or fold line as described below. As is most preferred, the carrier web 21 is completely uncut by cuts or partial severing. The carrier web 21 can, however, be provided with cuts or partial severing of a nature that do not destroy the capability of the composite label web 20 to be used in a label applicator. Therefore, certain cuts in the carrier web 21 can be tolerated. It is preferred that transverse partial severing in the carrier web, as are commonly used to separate one composite label sheet LS from an adjacent composite label sheet LS, be avoided because partial severing may cause tearing which would interfere with the capability of the composite label web 20 to be used in a label applicator. Also, if the knives that make the cuts 26 and/or 27 and/or the partial severing 35 cut into the carrier web 21, that is not a problem so long as the carrier web 21 is not weakened to a point that the carrier web 21 tears during manufacture or application of the leading label sheet or while advancing the composite label web 20 in a label applicator.

As shown diagrammatically in FIG. 6, the composite label web 20 is disposed in a label applicator generally indicated at 44. Such an applicator 44 can typically print a label, that is, a label sheet disposed at a printing position between a thermal print head 45 and a platen roll 46, but other types of printers such as ink jet, xerographic and others can be used instead. As the composite label web 20 is advanced in the direction of arrow A by the platen roll 46 and/or a feeder (not shown) that pulls on the carrier web 21 at a location downstream of the printing position, the print head 45 prints on the leading label. A delaminator 47 such as a peel roller or peel bar disposed downstream causes the carrier web 21 to make a sharp change in direction, which causes the leading label to be dispensed into underlying, label applying relationship to a presser foot or applicator pad 48. As noted above, the lands 26′ prevent the label sheet 22 from separating from the seals S1 and S2 or from following around the delaminator 47 while the label sheet LS is being dispensed. Thus, the entire label sheet LS is dispensed into underlying relation to the applicator pad 48 and is applied in tact to container C1. The presser foot 48 is reciprocally movable by actuating a rod 49 attached to the presser foot 48. When the presser foot 48 is moved downwardly as shown in FIG. 6, the entire leading label sheet 22 which is beneath the presser foot 48 is applied to an article such as a container C, as shown in FIG. 7.

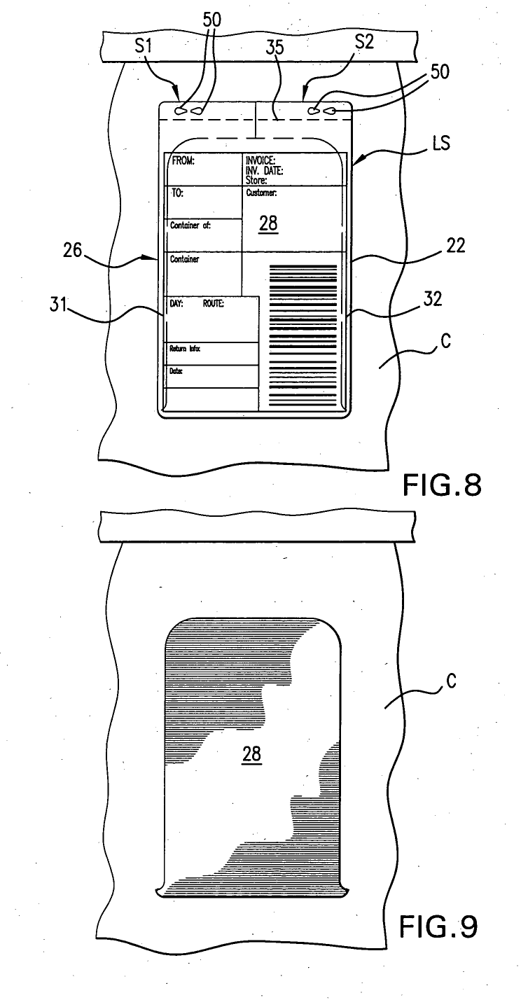

FIG. 8 shows the label sheet 22 applied to the container C. As shown, the label sheet 22 includes, in the illustrated embodiment, the label 28 and the security seals S1 and S2.

FIG. 9 shows the security seals S1 and S2 as having been removed, that is, peeled from the container C, leaving the label 28 in place.

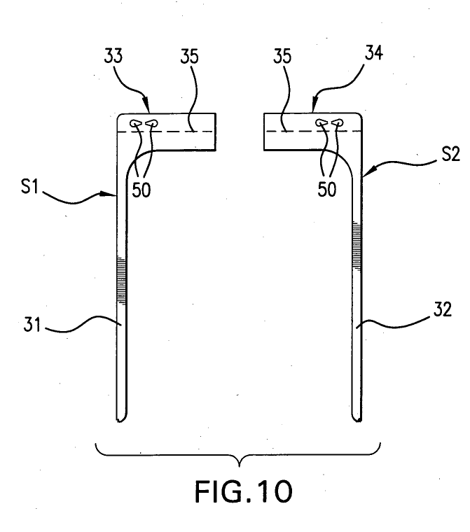

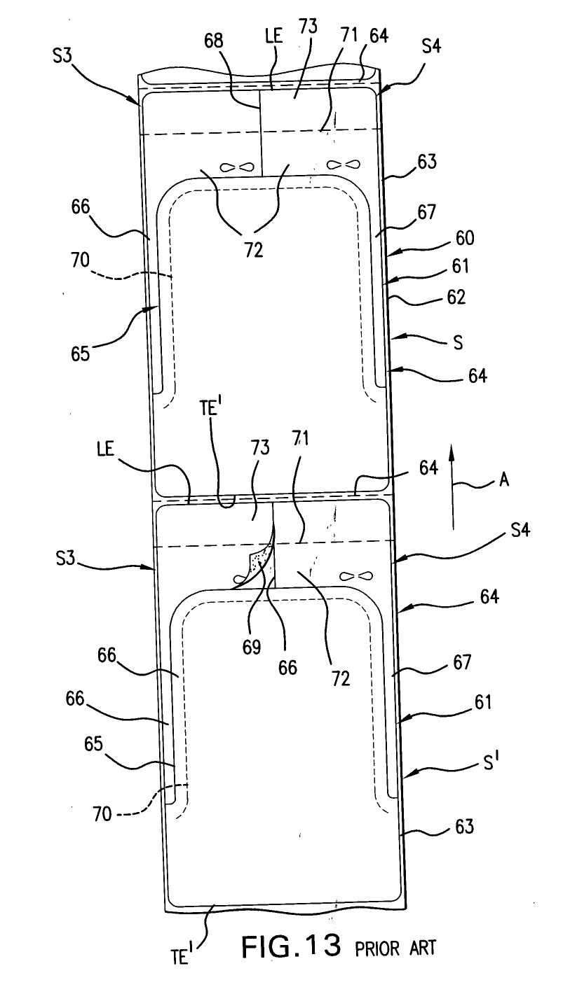

FIG. 10 shows the security seals S1 and S2 as having been removed from the container C and ready to be formed into security loops. In that there is no longer a carrier web portion under the seals S1 and S2, it is unnecessary to remove it. FIG. 12 shows one of the security seals S1 formed into a closed loop or a security loop. The transverse portion 33 has been folded about the partial severing line or hinge 35 with end portion 31′ disposed or sandwiched between portions 33′ and 33″ of the transverse portion 33. The adhesive 24 permanently holds the seal S1 for example in loop form until the seal S1 is broken by tearing the leg portion 31 or peeling portions 33′ and 33″ apart to release marginal end portion 31′ of the leg portion 31. Security cuts 50 in the portions 33 and 34 assist in indicating tampering in the event portions 33′ and 33″ are attempted to be peeled apart to release the captive end portion 31′.

The adhesive 24 is preferably of an adhesivity that enables the entire label sheet 22 including the seals S1 and S2 to be applied to containers C without tearing, but enables the seals to be thereafter peeled or removed from the containers C and formed into loops (FIG. 12) which cannot be torn, undone or peeled apart without indicating tampering.

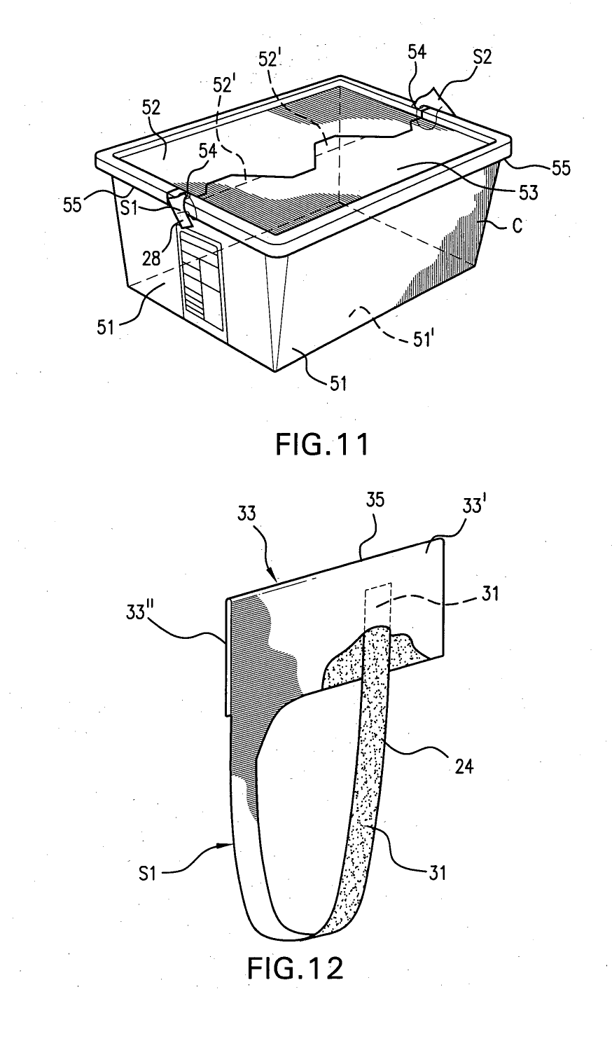

FIG. 11 shows that the container C has four sides 51, a bottom 51′ joined to the sides 51 and two, hinged, pivoted flaps 52 and 53. The container C and its flaps 52 and 53 are constructed of substantially rigid plastics material. When the flaps 52 and 53 are in the closed position, the flap 53 prevents the flap 52 from opening. The flap 52 has projections 52′ which underlie projections 53′ on the flap 53. Leg portions 31 and 32 of security seals S1 and S2 pass through holes 54 in the flap 53 and through holes (not shown) in a flange 55 of the container C. If the security seals S1 and S2 are broken or opened, it indicates tampering.

The composite label web 20 is usable in the following manner. The web 20 in either roll or fanfold form is disposed or loaded into a suitable label applicator 41 of the type, for example, that applies the label sheet 22 automatically onto a container C moving down a conveyor line. The automatic label applicator 44 typically includes a printer or print engine which prints data on the label sheet 22 before being dispensed into label applying relationship under the presser foot 48. The container C was previously loaded with articles such as magazines or books. Only when the container C reaches its destination at the publisher or distributor are the security seals S1 and S2 to be broken and the contents accounted for by the recipient.

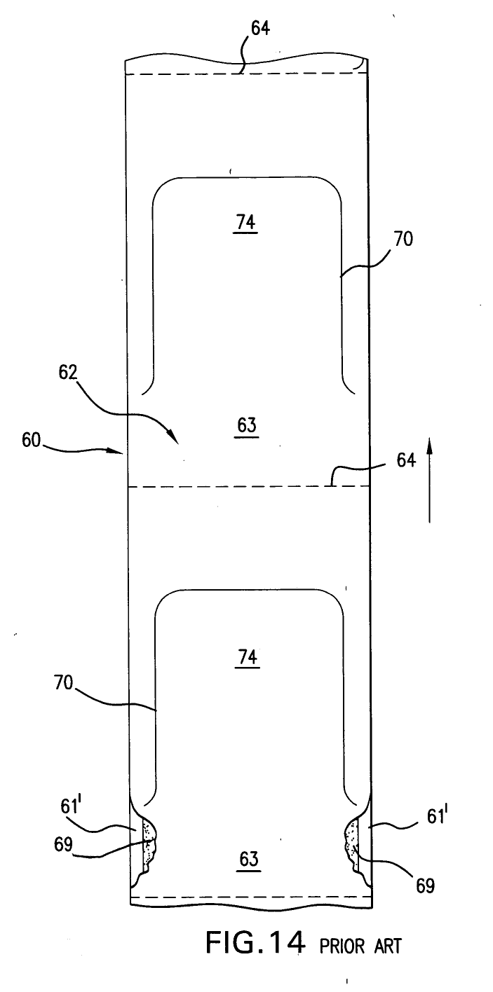

The prior art composite label web and its use are illustrated in FIGS. 13 through 16. The prior art composite label web generally indicated at 60 includes label sheets 61 on a carrier web 62. The composite label web 60 is capable of being printed in a printer and the label sheets 61 are applied by hand but the composite label web 60 is not capable of being dispensed in a label applicator because it would be torn while the label sheets 61 were being dispensed. The carrier web 62 includes carrier sheets 63 hingedly connected at transversely extending lines of partial severing 64, namely, perforations. Each label sheet 61 and its underlying label carrier sheet 63 constitute a composite label sheet LS connected at partial severing lines 64. The partial severing lines 64 aid in tearing one composite label sheet 64 from the adjacent composite label sheet 64 by hand. Generally U-shaped continuous cuts 65 (shown by solid lines) in the label sheets 61 terminate a substantial distance from the trailing end TE of the label sheet 61, and thus leg portions 66 and 67 of security seals S3 and S4 are relatively short. Therefore, the loops made by the seals S3 and S4 are short. A cut 68 through each label sheet 61, together with the cut 64, form security seal S3 and S4. The label sheets 61 have pressure sensitive or tacky adhesive 69 on its entire underside except for marginal edges 61′ (FIG. 14). The carrier web 62 has U-shaped cuts 70 (shown by solid lines in FIG. 14 and by a light dash-dash line in FIG. 13) which are slightly offset from the cuts or cut lines 65. The cuts 70 extend completely through he carrier sheets 63 of the carrier web 62, but preferably not into or through the label sheets 61. Cuts of partial severing 71 in the security seals S3 and S4 provide a hinge that enables portions 72 and 73 to be folded upon each other.

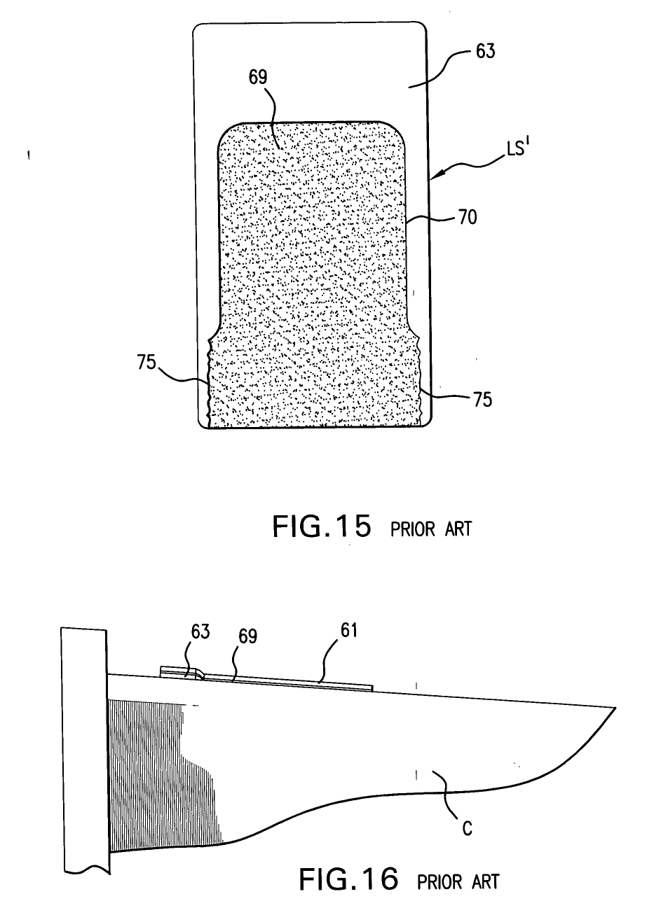

The portions of the carrier sheets 63 that lie within the U-shaped cuts 70 comprise covers 74 for the adhesive 69. The covers 74 act as tabs which facilitate manual removal and exposure of the adhesive 24, but they prevent the composite label sheet LS′ from being dispensed in a label applicator. As shown in FIG. 15, the seals S3 and S4 and the underlying portions of the carrier sheet 63 have been separated from the remainder of the composite label sheet S′. The seals S3 and S4 do not stick to the container C because of the underlying portions of the carrier sheet 63. The cover or tab 74 has been removed by grasping it manually and tearing it off. This act results in separation of not only the portion of the cover 74 within the cut line 70 but also tearing of an additional portion of the carrier sheet along jagged lines 75 in the carrier sheet 63. Thereafter, the exposed adhesive 69 is used to apply the remainder of the composite label sheet LS′ to a container such as the container C as shown in FIG. 16. The security seals S3 and S4 and the underlying portions of the carrier sheet 63 are shown in FIG. 17. The security seals S3 and S4 can now be peeled from the carrier sheet 63 and formed into loops to seal the container, such as the container C.

Other embodiments and modifications of the invention will suggest themselves to those skilled in the art, and all such of these as come within the spirit of this invention are included within its scope as best defined by the appended claims.

We claim:

1-10. (canceled)

11. A composite label web, comprising:
a longitudinally extending carrier web having a release coating,
label sheets having leading and trailing ends disposed along the carrier web and having pressure sensitive adhesive releasably adhering the label sheets to the release coating of the carrier web,
a set of cut lines in each label sheet, each set of cut lines including a generally U-shaped cut line through each label sheet but not through the carrier web, each set of cut lines also including a longitudinally extending cut line between the leading end of each label sheet and the U-shaped cut line,
the carrier web being free of any cut that could constitute a tab to cause tearing of the carrier web and prevent application of the label sheets from a label applicator onto articles to be labeled, wherein each set of cut lines defines a generally rectangular label and a pair of related L-shaped security seals, each L-shaped security seal including a transverse portion and a longitudinally extending portion, wherein each transverse portion of each label sheet is connected to the related label by a frangible portion, wherein each pair of transverse portions terminates at the leading end of the label sheet and the related longitudinally extending portions extend from the transverse portions toward the trailing end of the label sheet.
